(19) United States
(12) Patent Application Publication
(10) Pub. No.: US 2001/0038517 A1
(43) Pub. Date: Nov. 8, 2001

(54) Magnetoresistive effect sensor, thin-film magnetic head with the sensor, manufacturing method of magnetoresistive effect sensor and manufacturing method of thin-film magnetic head with the sensor

(75) Inventor: Akifumi Kamijima, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: TDK CORPORATION, Tokyo (JP)

(21) Appl. No.: 09/777,861

(22) Filed: Jun. 18, 2001

(30) Foreign Application Priority Data
Feb. 10, 2000 (JP) 033441/2000

(51) Int. Cl. G11B 5/39

(52) U.S. Cl. 360/320; 360/322; 360/324.2; 29/603.14

(57) ABSTRACT

A MR sensor includes a MR layer formed between a lower shield layer and an upper shield layer through a first lower insulation layer and a first upper insulation layer, respectively, a pair of lead conductor layers formed between the lower shield layer and the upper shield layer through the first lower insulation layer and the first upper insulation layer, respectively, the lead conductor layers being connected with both ends of the MR layer, and second upper insulation layers formed on the lead conductor layers and provided with substantially the same pattern shape as that of the lead conductor layers.

### FIELD OF THE INVENTION

The present invention relates to a magnetoresistive effect (MR) sensor, to a thin-film magnetic head with a MR sensor, to a method of manufacturing a MR sensor, and to a method of manufacturing a thin-film magnetic head with a MR sensor.

### DESCRIPTION OF THE RELATED ART

In connection with recent demand for higher recording density in a magnetic recording medium such as a magnetic disk, a thin-film magnetic head for reading and writing of magnetic information has been more miniaturized in size along the track width direction and also along the track length direction. The miniaturization in the size along the direction of track length requires the magnetic head to make its insulation film such as a shield gap layer thinner.

However, if the insulation film is made thinner, as a natural result, its insulation strength falls. Thus, a certain countermeasure for conquering this is necessary. Especially, in a MR sensor, it is very important that its shield gap layers located between lower and upper shield layers and a MR layer and its lead conductors through which current is always flowing in operation provide a sufficient insulation strength.

Japanese patent publication No. 06111248A discloses an additional insulation film or a second shield gap film partially formed between the stepped edges of electrodes and of a MR element and a shield layer in order to increase the thickness of the insulation film at that area and therefore to increase its insulation strength.

However, in this known structure, no additional insulation film other than the normal insulation film is formed at the area near the MR element between the lead conductors and the shield layer. Thus, the insulation strength at this area is insufficient causing the yield of the product to become worse.

Furthermore, in order to fabricate the above-mentioned known structure, an additional process for depositing the additional insulation film or the second shield gap film and for patterning the deposited film is required in addition to a process for depositing the ordinal insulation film or the first shield gap film and for patterning the deposited film. Thus, the manufacturing process becomes complicated and its manufacturing cost increases.

### SUMMARY OF THE INVENTION

It is therefore an object of the present invention to provide a MR sensor, a thin-film magnetic head with a MR sensor, a method of manufacturing a MR sensor to a method of manufacturing a thin-film magnetic head with a MR sensor, whereby deterioration in yield due to insufficient insulation strength of an shield insulation layer can be prevented.

Another object of the present invention is to provide a MR sensor, a thin-film magnetic head with a MR sensor, a method of manufacturing a MR sensor to a method of manufacturing a thin-film magnetic head with a MR sensor, whereby the insulation strength of the shield insulation layer can be improved without substantial additions in a manufacturing process.

According to the present invention, a MR sensor includes a MR layer formed between a lower shield layer and an upper shield layer through a first lower insulation layer and a first upper insulation layer, respectively, a pair of lead conductor layers formed between the lower shield layer and the upper shield layer through the first lower insulation layer and the first upper insulation layer, respectively, the lead conductor layers being connected with both ends of the MR layer, and second upper insulation layers formed on the lead conductor layers and provided with substantially the same pattern shape as that of the lead conductor layers. A thin-film magnetic head according to the present invention is provided with the above-mentioned MR sensor.

On the lead conductor layers, the second upper insulation layers with substantially the same pattern shape as that of the lead conductor layers are additionally formed. Thus, between the lead conductor layers and the upper shield layer, both the first upper insulation layer and the second upper insulation layers are inserted without exception. Therefore, insulation of not only a partial area near the MR layer but also the whole area of the lead conductor layers with respect to the upper shield layer becomes greatly improved. As a result, it is possible to surely prevent deterioration in yield due to insufficient insulation strength of the upper insulation layer from occurring.

It is preferred that the sensor further includes a second lower insulation layer formed on a part of the first lower insulation layer.

It is also preferred that the sensor further includes a pair of domain control layers located at the both ends of the MR layer, respectively.

Preferably, the MR layer is a MR layer with a single layer structure, a giant magnetoresistive effect (GMR) layer with a multi-layered structure, or a tunneling magnetoresistive effect (TMR) layer with a multi-layered structure.

Also, according to the present invention, a method of manufacturing a MR sensor includes a step of depositing a MR layer on a lower shield layer through a first lower insulation layer, a step of patterning the MR layer by forming a resist mask on the MR layer and by etching using the resist mask, a step of depositing a pair of lead conductor layers by using the resist mask, the lead conductor layers being connected with both ends of the MR layer, a step of depositing second upper insulation layers by using the resist mask on the lead conductor layers, a step of removing the resist mask, and a step of forming an upper shield layer thereon through a first upper insulation layer. A manufacturing method of a thin-film magnetic head according to the present invention includes the above-mentioned manufacturing method of a MR sensor.

Since the resist mask used for forming the lead conductor layers is reused as it is to form the second upper insulation layers, the second upper insulation layers with substantially the same pattern shape as that of the lead conductor layers can be additionally formed above the lead conductor layers without making another resist pattern. Thus, between the lead conductor layers and the upper shield layer, both the first upper insulation layer and the second upper insulation layers are inserted without exception. Therefore, insulation of not only a partial area near the MR layer but also the whole area of the lead conductor layers with respect to the upper shield layer becomes greatly improved. As a result, it is possible to surely prevent deterioration in yield due to insufficient insulation strength of the upper insulation layer from occurring. In addition, since the insulation strength of the shield insulation layer can be improved without substantial additions in a manufacturing process, it is prevented the manufacturing process from being complicated and the manufacturing cost from increasing.

It is preferred that the method further includes a step of forming a second lower insulation layer on a part of the first lower insulation layer, the MR layer depositing step being executed after the second lower insulation layer forming step.

It is also preferred that the method further includes a step of depositing a pair of domain control layers by using the resist mask after the lead conductor layers depositing step.

Preferably, the MR layer is a MR layer with a single layer structure, a GMR layer with a multi-layered structure, or TMR layer with a multi-layered structure.

Further objects and advantages of the present invention will be apparent from the following description of the preferred embodiments of the invention as illustrated in the accompanying drawings.

### BRIEF DESCRIPTION OF THE DRAWINGS

FIG. 1 shows a sectional view schematically illustrating a structure of a MR sensor which constitutes a reading head section of a thin-film magnetic head as a preferred embodiment according to the present invention;

FIGS. 2a to 2k show sectional views illustrating processes for manufacturing the MR sensor according to the embodiment shown in FIG. 1; and

FIG. 3 shows a plane view illustrating one MR sensor formed on a substrate during the process shown in FIG. 2e.

### DESCRIPTION OF THE PREFERRED EMBODIMENTS

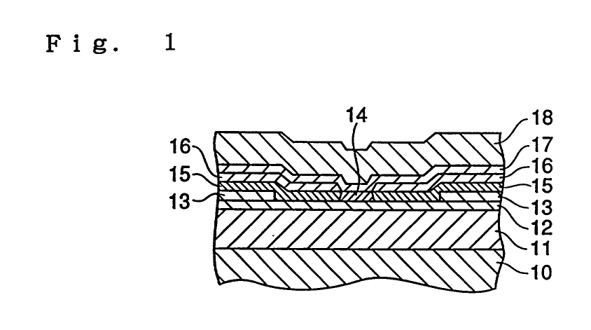

FIG. 1 schematically illustrates a structure of a MR sensor which constitutes a reading head section of a thin-film magnetic head as a preferred embodiment according to the present invention. This figure indicates a section of one MR sensor on a wafer cut by a plane that is in parallel with a magnetic sensitive face or an air bearing surface (ABS) in case of the magnetic head.

In the figure, reference numeral 10 denotes a substrate or a wafer, 11 a lower shield layer deposited on an under film (not shown) which is formed on the substrate 10, 12 a first lower insulation layer or a first lower shield gap layer deposited on the lower shield layer 11, 13 a second lower insulation layer or a second lower shield gap layer deposited on a part of the first lower insulation layer 12 and patterned, 14 a MR layer formed on the first lower insulation layer 12, and 15 a pair of lead conductor layers formed on the first lower insulation layer 12 and the second lower insulation layer 13 and connected with track-width direction ends of the MR layer 14, respectively.

In stead of the lead conductor layers 15, a pair of multi-layers of lead conductor layers and bias generation or magnetic domain control layers for providing longitudinal bias for controlling magnetic domain in the MR layer 14 may be used.

In the figure, furthermore, reference numeral 16 denotes a pair of second upper insulation layers or second upper shield gap layers formed on the lead conductor layers or the multi-layers of the lead conductors layer and the bias generation layers 15 and provided with substantially the same pattern shape as the lead conductor layers or the multi-layers, 17 a first upper insulation layer or a first upper shield gap layer deposited on the MR layer 14 and the second upper insulation layers 16, and 18 an upper shield layer formed on the first upper insulation layer 17, respectively.

In case of a composite thin-film magnetic head with both reading and writing head sections, an inductive writing head section is formed on the upper shield layer 18.

The MR layer 14 may be a general MR film with a single layer structure utilizing anisotropic magnetoresistive effect (AMR), a GMR film with a multi-layered structure utilizing for example spin-valve effect, or a TMR film with a multi-layered structure.

As aforementioned, according to this embodiment, on the lead conductor layers 15 or the multi-layers 15 of the lead conductors layer and the bias generation layers for each MR sensor, the pair of second upper insulation layers 16 with substantially the same pattern shape as that of the lead conductor layers or the multi-layers 15 are formed in addition to the first upper insulation layer 17. Thus, between the lead conductor layers or the multi-layers 15 and the upper shield layer 18, both the first upper insulation layer 17 and the second upper insulation layers 16 are inserted without exception. Therefore, insulation of not only a partial area near the MR layer 14 but also the whole area of the lead conductor layers or the multi-layers 15 with respect to the upper shield layer 18 becomes greatly improved. As a result, it is possible to surely prevent deterioration in yield due to insufficient insulation strength of the upper insulation layer from occurring.

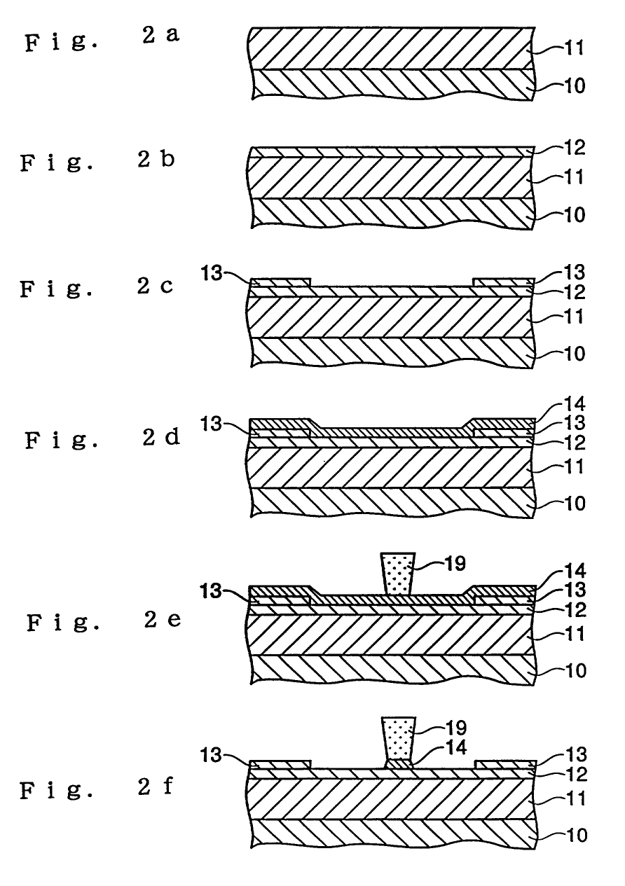

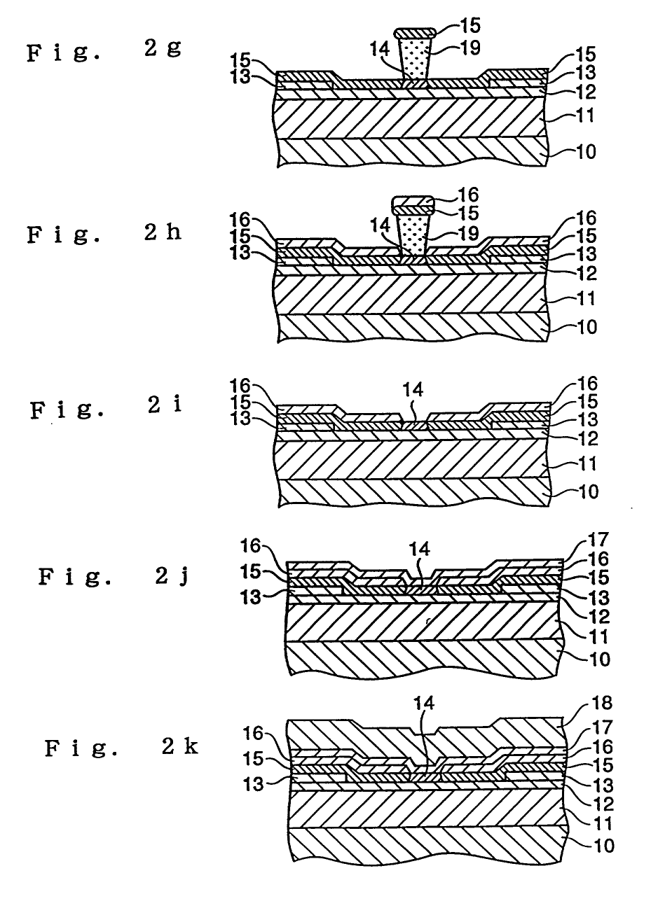

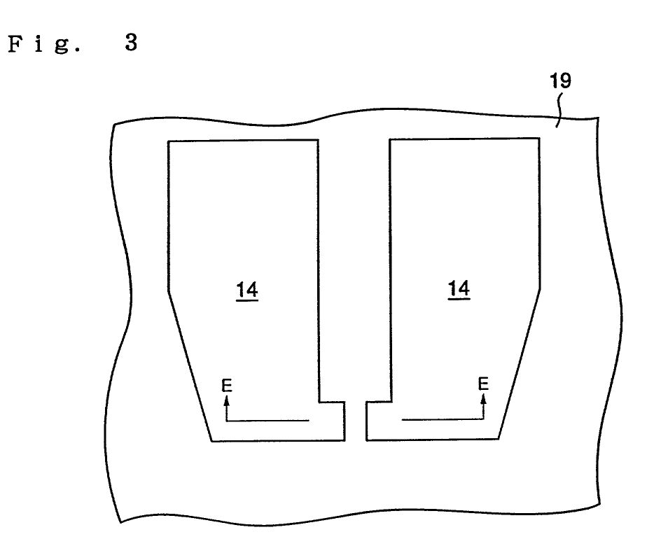

FIGS. 2a to 2k illustrate processes for manufacturing the MR sensor according to the embodiment shown in FIG. 1. These figures indicate a section of one MR sensor on a wafer cut by a plane that is in parallel with the ABS.

First, as shown in FIG. 2a, a lower shield layer 11 is deposited on an under film (not shown) which is formed on a substrate or a wafer 10 by plating for example. Then, as shown in FIG. 2b, a first lower insulation layer 12 is deposited on the lower shield layer 11 by sputtering for example Al₂O₃ or SiO₂.

Thereafter, as shown in FIG. 2c, a second lower insulation layer 13 is formed on a part of the first lower insulation layer 12 by sputtering for example Al₂O₃ or SiO₂ and by patterning the deposited layer using the lift-off method.

Then, as shown in FIG. 2d, a MR layer 14 is deposited on the first lower insulation layer 12 and the second lower insulation layer 13.

Thereafter, as shown in FIG. 2e, a patterned resist mask 19 is formed on the MR layer 14. FIG. 3 illustrates one MR sensor portion formed on the substrate at this stage. An E-E line sectional view of FIG. 3 corresponds to FIG. 2e.

Then, as shown in FIG. 2f, a part of the MR layer 14 which is not covered by the resist mask 19 is removed by etching. The etching may be a dry etching such as ion milling.

Then, as shown in FIG. 2g, a pair of lead conductor layers or a pair of multi-layers of lead conductor layers and bias generation or magnetic domain control layers 15 connected with track-width direction ends of the MR layer 14 are formed on the first lower insulation layer 12 and the second lower insulation layer 13 by sputtering using this same resist mask 19.

Then, as shown in FIG. 2h, a pair of second upper insulation layers 16 with substantially the same pattern shape as the lead conductor layers or the multi-layers of the lead conductors layer and the bias generation layers 15 are formed on the lead conductor layers or the multi-layers 15 by sputtering for example Al₂O₃ or SiO₂ using this same resist mask 19.

Thereafter, as shown in FIG. 2i, the resist mask 19 is removed by using an organic solvent.

Then, as shown in FIG. 2j, a first upper insulation layer 17 is deposited on the MR layer 14 and the second upper insulation layers 16 by sputtering for example Al₂O₃ or SiO₂. Thereafter, as shown in FIG. 2k, an upper shield layer 18 is formed by plating for example on the first upper insulation layer 17.

In case of a composite thin-film magnetic head, an inductive writing head section is then formed on the upper shield layer 18.

Since the resist mask 19 used for forming the lead conductor layers or the multi-layers of lead conductor layers and bias generation or magnetic domain control layers 15 is reused as it is to form the second upper insulation layers 16, the second upper insulation layers 16 with substantially the same pattern shape as that of the lead conductor layers or the multi-layers 15 can be additionally formed above the lead conductor layers or the multi-layers 15 without making another resist pattern. Thus, between the lead conductor layers or the multi-layers 15 and the upper shield layer 18, both the first upper insulation layer 17 and the second upper insulation layers 16 are inserted without exception. Therefore, insulation of not only a partial area near the MR layer 14 but also the whole area of the lead conductor layers or the multi-layers 15 with respect to the upper shield layer 18 becomes greatly improved. As a result, it is possible to surely prevent deterioration in yield due to insufficient insulation strength of the upper insulation layer from occurring. In addition, since the insulation strength of the shield insulation layer can be improved without substantial additions in a manufacturing process, it is prevented the manufacturing process from being complicated and the manufacturing cost from increasing.

Although the above-mentioned embodiment concerns the MR sensor of the thin-film magnetic head, the present invention can be applied to any MR sensor used for magnetic detection.

Many widely different embodiments of the present invention may be constructed without departing from the spirit and scope of the present invention. It should be understood that the present invention is not limited to the specific embodiments described in the specification, except as defined in the appended claims.

What is claimed is:

1. A magnetoresistive effect sensor comprising:
a magnetoresistive effect layer formed between a lower shield layer and an upper shield layer through a first lower insulation layer and a first upper insulation layer, respectively;
a pair of lead conductor layers formed between said lower shield layer and said upper shield layer through said first lower insulation layer and said first upper insulation layer, respectively, said lead conductor layers being connected with both ends of said magnetoresistive effect layer; and
second upper insulation layers formed on said lead conductor layers and provided with substantially the same pattern shape as that of said lead conductor layers.

2. The sensor as claimed in claim 1, wherein said sensor further comprises a second lower insulation layer formed on a part of said first lower insulation layer.

3. The sensor as claimed in claim 1, wherein said sensor further comprises a pair of domain control layers located at the both ends of said magnetoresistive effect layer, respectively.

4. The sensor as claimed in claim 1, wherein said magnetoresistive effect layer is a magnetoresistive effect layer with a single layer structure.

5. The sensor as claimed in claim 1, wherein said magnetoresistive effect layer is a giant magnetoresistive effect layer with a multi-layered structure.

6. The sensor as claimed in claim 1, wherein said magnetoresistive effect layer is a tunneling magnetoresistive effect layer with a multi-layered structure.

7. A thin-film magnetic head with a magnetoresistive effect sensor, said sensor comprising:
a magnetoresistive effect layer formed between a lower shield layer and an upper shield layer through a first lower insulation layer and a first upper insulation layer, respectively;
a pair of lead conductor layers formed between said lower shield layer and said upper shield layer through said first lower insulation layer and said first upper insulation layer, respectively, said lead conductor layers being connected with both ends of said magnetoresistive effect layer; and
second upper insulation layers formed on said lead conductor layers and provided with substantially the same pattern shape as that of said lead conductor layers.

8. A method of manufacturing a magnetoresistive effect sensor, comprising the steps of:
depositing a magnetoresistive effect layer on a lower shield layer through a first lower insulation layer;
patterning said magnetoresistive effect layer by forming a resist mask on the magnetoresistive effect layer and by etching using said resist mask;
depositing a pair of lead conductor layers by using said resist mask, said lead conductor layers being connected with both ends of said magnetoresistive effect layer;
depositing second upper insulation layers by using said resist mask on said lead conductor layers;
removing said resist mask; and
forming an upper shield layer thereon through a first upper insulation layer.

9. The manufacturing method as claimed in claim 8, wherein said method further comprises a step of forming a second lower insulation layer on a part of said first lower insulation layer, said magnetoresistive effect layer depositing step being executed after said second lower insulation layer forming step.

10. The manufacturing method as claimed in claim 8, wherein said method further comprises a step of depositing a pair of domain control layers by using said resist mask after said lead conductor layers depositing step.

11. The manufacturing method as claimed in claim 8, wherein said magnetoresistive effect layer is a magnetoresistive effect layer with a single layer structure.

12. The manufacturing method as claimed in claim 8, wherein said magnetoresistive effect layer is a giant magnetoresistive effect layer with a multi-layered structure.

13. The manufacturing method as claimed in claim 8, wherein said magnetoresistive effect layer is a tunneling magnetoresistive effect layer with a multi-layered structure.

14. A method of manufacturing a thin-film magnetic head using a manufacturing method of a magnetoresistive effect sensor comprising the steps of:
depositing a magnetoresistive effect layer on a lower shield layer through a first lower insulation layer;
patterning said magnetoresistive effect layer by forming a resist mask on the magnetoresistive effect layer and by etching using said resist mask;
depositing a pair of lead conductor layers by using said resist mask, said lead conductor layers being connected with both ends of said magnetoresistive effect layer;
depositing second upper insulation layers by using said resist mask on said lead conductor layers;
removing said resist mask; and
forming an upper shield layer thereon through a first upper insulation layer.
